(19) United States
(12) Patent Application Publication
(10) Pub. No.: US 2019/0333656 A1
(43) Pub. Date: Oct. 31, 2019

(54) METHOD OF MANUFACTURING CONDUCTIVE FILM AND CONDUCTIVE FILM

(71) Applicant: FUJIFILM Corporation, Tokyo (JP)

(72) Inventor: Takahiko ICHIKI, Kanagawa (JP)

(73) Assignee: FUJIFILM Corporation, Tokyo (JP)

(21) Appl. No.: 16/460,462

(22) Filed: Jul. 2, 2019

Related U.S. Application Data
(63) Continuation of application No. PCT/JP2018/002767, filed on Jan. 29, 2018.

(30) Foreign Application Priority Data
Feb. 27, 2017 (JP) 2017-034540

(51) Int. Cl. H01B 5/14; H01B 13/00; G06F 3/044; C25D 3/12; C25D 3/38; C25D 5/02; C25D 5/12; C25D 5/56

(52) U.S. Cl. CPC H01B 5/14; H01B 13/0036; G06F 3/044; C25D 3/12; G06F 2203/04103; C25D 5/022; C25D 5/12; C25D 5/56; C25D 3/38

(57) ABSTRACT

A method of manufacturing a conductive film includes forming a first metallic film containing nickel as a main component on at least one main surface of the transparent resin substrate so as to be in contact with the transparent resin substrate, forming a second metallic film containing copper as a main component on the first metallic film, forming, on the second metallic film, a resist film provided with openings in a region where the metallic thin wires are formed, removing the second metallic film in the openings, forming a third metallic film on the first metallic film in the openings by a plating method, removing the resist film, removing the second metallic film on the first metallic film, and removing the first metallic film using the third metallic film as a mask.

### CROSS-REFERENCE TO RELATED APPLICATIONS

This application is a Continuation of PCT international Application No. PCT/JP2018/002767, filed on Jan. 29, 2018, which claims priority under 35 U.S.C. § 119(a) to Japanese Patent Application No. 2017-034540, filed on Feb. 27, 2017. Each of the above application(s) is hereby expressly incorporated by reference, in its entirety, into the present application.

### BACKGROUND OF THE INVENTION

### 1. Field of the Invention

The present invention relates to a method of manufacturing a conductive film and a conductive film.

### 2. Description of the Related Art

Conductive films in which a conductive portion formed of metallic thin wires is disposed on a transparent resin substrate are used for various purposes. For example, with an increase of a rate of mounting of touch panels on mobile phones or portable game devices, a demand for conductive films for a capacitive touch panel sensor allowing multipoint detection has been rapidly expanded in recent years.

For example, in using a display provided with a touch panel, a user looks at the display from a distance of several tens of centimeters from the display. In this case, it is required to further reduce a width of metallic thin wires in order to prevent the metallic thin wires from being visually recognized by the user.

As a technology for the above problem, JP2015-225650A describes “a method of manufacturing a fine structure of metallic wires, including: (a) a step of providing a substrate; (b) a step of forming a seed layer on a surface of the substrate; (c) a step of forming grooves having a predetermined width in a photoresist layer by forming the photoresist layer on a surface of the seed layer and performing photolithography and an etching process; (d) a step of filling the grooves with a conductive layer; and (e) a step of forming a fine structure of metallic wires by removing the photoresist layer and a seed layer part not covered with the conductive layer”.

### SUMMARY OF THE INVENTION

The inventors have studied the method of manufacturing a fine structure of metallic wires described in JP2015-225650A, and found that in obtaining metallic thin wires having a smaller width, the metallic thin wires are detached from the substrate.

Accordingly, an object of the invention is to provide a method of manufacturing a conductive film, by which a conductive film provided with metallic thin wires having excellent adhesiveness to a transparent resin substrate can be obtained. Another object of the invention is to provide a conductive film.

The inventors have performed intensive studies for achieving the objects, and as a result, found that the objects can be achieved by the following configuration.

[1] A method of manufacturing a conductive film provided with a transparent resin substrate and a conductive portion formed of metallic thin wires disposed on at least one main surface of the transparent resin substrate, comprising, in order: a step of forming a first metallic film containing nickel as a main component on at least one main surface of the transparent resin substrate so as to be in contact with the transparent resin substrate; a step of forming a second metallic film containing copper as a main component on the first metallic film so as to be in contact with the first metallic film; a step of forming, on the second metallic film, a resist film provided with openings in a region where the metallic thin wires are formed; a step of removing the second metallic film in the openings; a step of forming a third metallic film on the first metallic film in the openings by a plating method; a step of removing the resist film; a step of removing the second metallic film on the first metallic film; and a step of removing the first metallic film using the third metallic film as a mask.

[2] The method of manufacturing a conductive film according to [1], in which a line width of the openings is 2.0 μm or less.

[3] The method of manufacturing a conductive film according to [1] or [2], in which a line width of the openings is 1.4 μm or less, and a thickness of the second metallic film is less than 50 nm.

[4] The method of manufacturing a conductive film according to any one of [1] to [3], in which a thickness of the third metallic film is 200 to 1,500 nm.

[5] A conductive film comprising: a transparent resin substrate; and a conductive portion formed of metallic thin wires disposed on at least one main surface of the transparent resin substrate, in which the metallic thin wires have a first metallic layer containing nickel as a main component and a third metallic layer containing copper as a main component in order from the transparent resin substrate, the first metallic layer is in contact with the transparent resin substrate, and a line width of the metallic thin wires is 2.0 μm or less.

[6] The conductive film according to [5], in which a variation in the line width of the metallic thin wires is 10% or less.

[7] The conductive film according to [5] or [6], in which a thickness of the third metallic layer is 200 to 1,500 nm.

According to the invention, it is possible to provide a method of manufacturing a conductive film, by which a conductive film provided with metallic thin wires having excellent adhesiveness to a transparent resin substrate can be obtained. According to the invention, it is also possible to provide a conductive film.

### BRIEF DESCRIPTION OF THE DRAWINGS

FIG. 1 is a schematic cross-sectional view of a first metallic film-attached transparent resin substrate.

FIG. 2 is a schematic cross-sectional view of a second metallic film-attached transparent resin substrate.

FIG. 3 is a schematic cross-sectional view of a resist film forming composition layer-attached transparent resin substrate.

FIG. 4 is a schematic cross-sectional view of a resist film-attached transparent resin substrate.

FIG. 5 is a schematic cross-sectional view of the resist film-attached transparent resin substrate from which a second metallic film in an opening has been removed.

FIG. 6 is a schematic cross-sectional view of a third metallic film-attached transparent resin substrate.

FIG. 7 is a schematic cross-sectional view of the third metallic film-attached transparent resin substrate from which a resist film has been removed.

FIG. 8 is a schematic cross-sectional view of the third metallic film-attached transparent resin substrate from which the remaining second metallic film has been removed.

FIG. 9 is a schematic cross-sectional view of an embodiment of a conductive film.

FIG. 10 is a top view of an embodiment of the conductive film.

FIG. 11 is a cross-sectional view taken along the line A-A of the top view of an embodiment of the conductive film.

FIG. 12 is a partially enlarged view of a conductive portion in the conductive film.

### DESCRIPTION OF THE PREFERRED EMBODIMENTS

Hereinafter, the invention will be described in detail.

The following description of constituent requirements may be based on representative embodiments of the invention, but the invention is not limited to the embodiments.

In this specification, a numerical value range expressed by using “to” means a range including numerical values described before and after “to” as a lower limit value and an upper limit value.

In this specification, the main component denotes a component having the largest content among components contained in a film.

In the description of groups (atomic groups) in this specification, the description in which neither “substituted” nor “unsubstituted” is labeled includes those having no substituent as well as those having a substituent. For example, an “alkyl group” includes not only an alkyl group having no substituent (an unsubstituted alkyl group), but also an alkyl group having a substituent (a substituted alkyl group).

In this specification, “actinic rays” or “radiation” means, for example, far ultraviolet rays, extreme ultraviolet (EUV) rays, X-rays, electron beams, and the like. In this specification, light means actinic rays and radiation. Unless otherwise specified, “exposure” includes not only exposure by far ultraviolet rays. X-rays, EUV, or the like, but also drawing by electron beams or particle beams such as and ion beams.

In this specification, a “monomer” is synonymous with a “monomer”. A monomer refers to a compound which is distinguished from an oligomer and a polymer and has a weight average molecular weight of 2,000 or less. In this specification, a polymerizable compound refers to a compound containing a polymerizable group, and may be a monomer or a polymer. The polymerizable group refers to a group related to a polymerization reaction.

[Method of Manufacturing Conductive Film]

The method of manufacturing a conductive film has the following steps in this order.

(1) A step of forming a first metallic film containing nickel as a main component on at least one main surface of a transparent resin substrate so as to be in contact with the transparent resin substrate (first metallic film forming step)

(2) A step of forming a second metallic film containing copper as a main component on the first metallic film so as to be in contact with the first metallic film (second metallic film forming step)

(3) A step of forming., on the second metallic film, a resist film provided with openings in a region where metallic thin wires are formed (resist film forming step)

(4) A step of removing the second metallic film in the openings (second metallic film removing step A)

(5) A step of forming a third metallic film on the first metallic film in the openings by a plating method (third metallic film forming step)

(6) A step of removing the resist film (resist film removing step)

(7) A step of removing the second metallic film on the first metallic film (second metallic film removing step B)

(8) A step of removing the first metallic film using the third metallic film as a mask (first metallic film removing step)

Hereinafter, the steps will be described in detail.

The first metallic film forming step is a step of forming a first metallic film containing nickel as a main component on at least one main surface of a transparent resin substrate so as to be in contact with the transparent resin substrate. As will be described later, a first metallic layer is formed in a case where the first metallic film is etched.

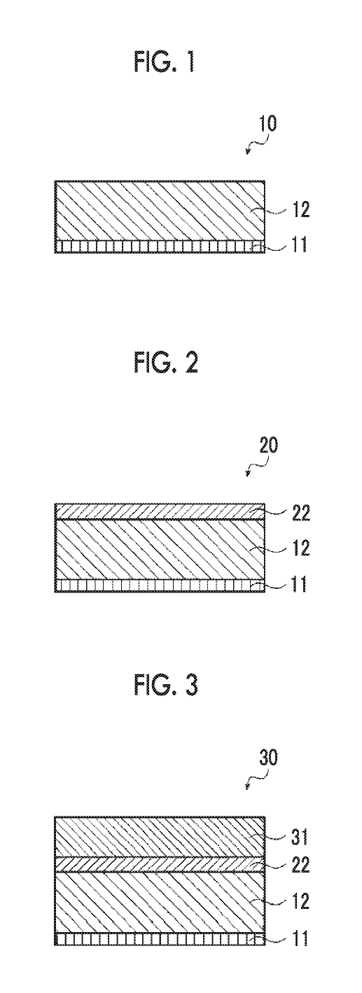

FIG. 1 shows a schematic cross-sectional view of a first metallic film-attached transparent resin substrate 10 formed through this step. In this step, typically, a first metallic film 12 is formed on one main surface of a transparent resin substrate 11 so as to be in contact with the transparent resin substrate 11 as shown in FIG. 1.

In FIG. 1, the first metallic film 12 is formed on one main surface of the transparent resin substrate 11, but the method of manufacturing a conductive film is not limited thereto. Two first metallic films 12 may be formed on both main surfaces of the transparent resin substrate 11 so as to be in contact with the transparent resin substrate 11.

[Transparent Resin Substrate]

The transparent resin substrate has main surfaces and functions to support a conductive portion. In this specification, transparent denotes that 60% or more of visible light (having a wavelength of 400 to 800 nm) is transmitted, preferably 80% or more, more preferably 90% or more, and even more preferably 95% or more. The transparent resin substrate may be colorless and transparent, or may be colored and transparent.

Examples of the material of the transparent resin substrate include polyether sulfone resins, polyacrylic resins, polyurethane resins, polyester resins (polyethylene terephthalate and polyethylene naphthalate), polycarbonate resins, polysulfone resins, polyamide resins, polyarylate resins, polyolefin resins, cellulose resins, polyvinyl chloride resins, and cycloolefin resins. Among these, cycloolefin resins (COP: Cyclo-Olefin Polymer) are preferable in view of the fact that these have more excellent optical properties.

The thickness of the transparent resin substrate is not particularly limited. The thickness is preferably 0.01 to 2 mm, and more preferably 0.04 to 1 mm in view of balance between handleability and a reduction in thickness.

The transparent resin substrate 11 may have a multilayer structure, and contain, for example, a functional film as one layer thereof. The transparent resin substrate itself may be a functional film.

[First Metallic Film]

The first metallic film is a metallic film which contains nickel as a main component and is disposed on at least one main surface of the transparent resin substrate so as to be in contact with the transparent resin substrate.

The main surfaces of the transparent resin substrate denote surfaces having the largest area and facing each other among surfaces of the transparent resin substrate, and correspond to surfaces opposed to each other in a thickness direction of the substrate.

In addition, the expression “so as to be in contact with” denotes that at least a part of the main surface of the transparent resin substrate is in contact with the main surface of the first metallic film.

The first metallic film contains nickel as a main component. Accordingly, the first metallic film has strong interaction with the transparent resin substrate, and thus has excellent adhesiveness to the transparent resin substrate. This tendency is particularly remarkable in a case where the material of the transparent resin substrate contains an oxygen atom.

In addition, since the first metallic film contains nickel as a main component, it has low electrical resistivity. A third metallic film is formed on the first metallic film by a plating method in a third metallic film forming step to be described later. That is, the first metallic film also functions as a seed layer in the plating step. Since the first metallic film contains nickel as a main component, it also has excellent adhesiveness to the third metallic film.

According to the method of manufacturing a conductive film, the first metallic film contains nickel as a main component. Accordingly, a first metallic film functioning as a seed layer can be formed without the formation of a layer for improving adhesiveness (hereinafter, also referred to as “adhesion layer”) between the first metallic film and the transparent resin substrate. According to the above description, according to the invention, it is possible to more easily obtain a conductive film provided with metallic thin wires having excellent adhesiveness to a transparent resin substrate.

The first metallic film contains nickel as a main component. The main component of the first metallic film denotes a metal having the largest content (mass) among materials (typically, metal) contained in the first metallic film.

The first metallic film may be a nickel alloy as long as it contains nickel as a main component. The first metallic film is preferably made of nickel.

The nickel content of the first metallic film is not particularly limited. The nickel content is preferably 80 mass % or greater, more preferably 90 mass % or greater, and even more preferably 98 mass % or greater with respect to a total mass of the first metallic film. The upper limit of the nickel content is not particularly limited, and generally preferably 100 mass % or less.

In the specification, the state in which the first metallic film is made of nickel denotes that the first metallic film does not substantially contain a component other than nickel. The case where the first metallic film does not substantially contain a component other than nickel includes a case where the first metallic film is made of nickel and a case where the first metallic film unintentionally contains a component other than nickel (typically, a case where a component other than nickel is contained as impurities).

The component other than nickel in the first metallic film is not particularly limited, and examples thereof include copper, chromium, lead, gold, silver, tin, and zinc.

The thickness of the first metallic film is not particularly limited, and generally preferably 10 to 200 nm, and more preferably 20 to 100 nm.

In a case where the thickness of the first metallic film is 10 to 200 nm, a conductive film to be obtained has more excellent adhesiveness and in-plane uniformity. In this specification, the in-plane uniformity denotes that mainly, a third metallic layer has a substantially uniform thickness in the plane.

The method of forming a first metallic film is not particularly limited, and a known forming method can be used. Especially, a sputtering method or a vapor deposition method is preferable in view of the fact that it is possible to form a film which is denser and has excellent adhesiveness to the transparent resin substrate.

[Second Metallic Film Forming Step]

The second metallic film forming step is a step of forming a second metallic film containing copper as a main component on the first metallic film so as to be in contact with the first metallic film.

In addition, the expression “so as to be in contact with” denotes that at least a part of the main surface of the first metallic film is in contact with the main surface of the second metallic film.

The main surfaces of the first metallic film denote surfaces having the largest area and facing each other among surfaces of the first metallic film, and correspond to surfaces opposed to each other in a thickness direction of the first metallic film. The same applies to the main surfaces of the second metallic film.

FIG. 2 is a schematic cross-sectional view of a second metallic film-attached transparent resin substrate 20 formed through this step. In this step, typically, a second metallic film 22 is formed on the first metallic film 12 formed on the main surface of the transparent resin substrate 11 so as to be in contact therewith as shown in FIG. 2.

In FIG. 2, one main surface of the second metallic film 22 is completely in contact with the main surface of the first metallic film 12 on the opposite side to the main surface coming into contact with the transparent resin substrate 11 among the main surfaces of the first metallic film 12. However, the second metallic film to be formed by the second metallic film forming step is not limited to the above-described form.

That is, the second metallic film 22 may be formed on the first metallic film 12 so as to be in contact with the first metallic film 12, and formed such that at least a part of the main surface of the first metallic film 12 is in contact with the main surface of the second metallic film 22.

The second metallic film functions as a protective film of the first metallic film.

The first metallic film contains nickel as a main component. Accordingly, the surface of the first metallic film is easily oxidized. In a case where a resist film is formed without the formation of the second metallic film, the first metallic film is particularly easily oxidized.

In a case where the surface of the first metallic film is oxidized, the seed layer function of the first metallic film is easily impaired. That is, in a case where in a state where the surface of the first metallic film is oxidized, a metallic film is further formed thereon by a plating method, adhesiveness between the metallic film to be formed and the first metallic film is easily impaired.

The oxide film of the first metallic film can be removed by an acid treatment or the like before the formation of a metallic film by a plating method. However, since the thickness of the oxide film of the first metallic film changes with the lapse of time, setting of conditions for the acid treatment becomes complicated.

In the method of manufacturing a conductive film, after the formation of the first metallic film, the second metallic film is formed on the first metallic film so as to be in contact therewith. Accordingly, oxidation of the first metallic film is suppressed by the second metallic film. The second metallic film is removed before the formation of a third metallic film to be described later, and the third metallic film is formed thereon before the first metallic film is oxidized. Accordingly, according to the method of manufacturing a conductive film, it is possible to obtain a conductive film provided with metallic thin wires having excellent adhesiveness to a transparent resin substrate.

The second metallic film contains copper as a main component. The main component of the second metallic film denotes a metal having the largest content (mass) among materials (typically, metal) contained in the second metallic film.

The second metallic film may be a copper alloy as long as it contains copper as a main component. The second metallic film is preferably made of copper.

The copper content of the second metallic film is not particularly limited. The copper content is preferably 70 mass % or greater, more preferably 80 mass % or greater, and even more preferably 85 mass % or greater.

The component other than copper in the second metallic film is not particularly limited, and examples thereof include chromium, lead, nickel, gold, silver, tin, and zinc.

In this specification, the state in which the second metallic film is made of copper denotes that the second metallic film does not substantially contain a component other than copper. The case where the second metallic film does not substantially contain a component other than copper includes a case where the second metallic film is made of copper and a case where the second metallic film unintentionally contains a component other than copper (typically, a case where a component other than copper is contained as impurities).

The thickness of the second metallic film is not particularly limited. The upper limit thereof is generally preferably 150 nm or less, more preferably 100 nm or less, even more preferably 50 nm or less, particularly preferably less than 50 nm, and most preferably 40 nm or less. The lower limit thereof is not particularly limited, and generally preferably 5 nm or greater, and more preferably 10 nm or greater. In a case where the thickness of the second metallic film is 5 to 150 nm, a conductive film to be obtained has more excellent line width uniformity (has a smaller variation in the width of the metallic thin wires).

Especially, in a case where a line width of openings of a resist film to be described later is 1.4 μm and the thickness of the second metallic film is less than 50 nm, a conductive film has more excellent line width uniformity.

The ratio of the line width (nm) of openings of a resist film to be described later to the thickness (nm) of the second metallic film (line width of openings/thickness of second metallic film) is not particularly limited. In general, the lower limit value thereof is preferably 2 or greater, more preferably 3 or greater, even more preferably 6 or greater, particularly preferably greater than 6, and most preferably 7.5 or greater. The upper limit value thereof is preferably 200 or less, and more preferably 140 or less.

In a case where the ratio of the line width (nm) of the openings to the thickness (nm) of the second metallic film is greater than 6 and not greater than 140, a conductive film has more excellent uniformity in the width of the metallic thin wires.

The ratio of the thickness (unit: nm) of the second metallic film to the thickness (unit: nm) of a third metallic film to be described later (thickness of second metallic film/thickness of third metallic film) is not particularly limited. In view of the fact that it is possible to obtain a conductive film with a smaller variation in the width of the metallic thin wires, the ratio is preferably less than 0.16. The ratio of the thickness of the second metallic film to the thickness of the third metallic film is not particularly limited, and generally preferably 0.001 or greater. In a case where the ratio of the thickness of the second metallic film to the thickness of the third metallic film is less than 0.16, a conductive film has more excellent line width uniformity.

The method of forming a second metallic film is not particularly limited, and a known forming method can be used. Especially, a sputtering method or a vapor deposition method is preferable in view of the fact that it is possible to form a film which is denser and has excellent adhesiveness to the transparent resin substrate.

[Resist Film Forming Step]

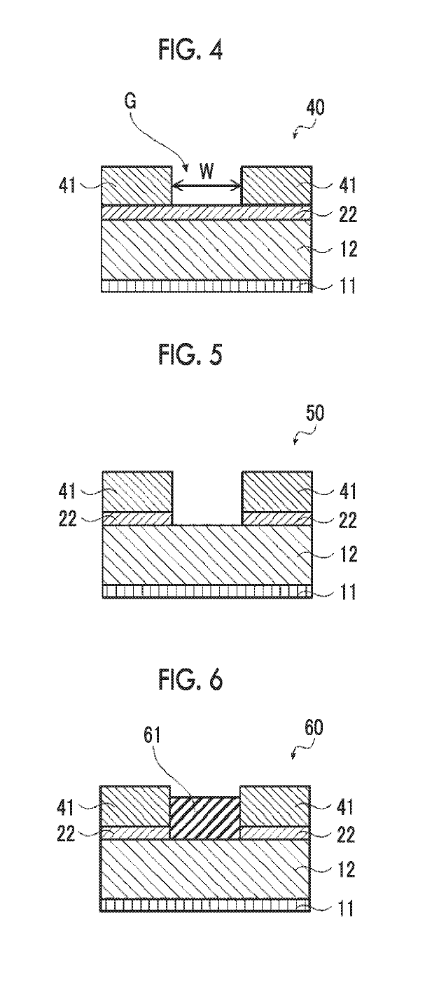

The resist film forming step is a step of forming a resist film provided with openings in a region where metallic thin wires are formed. FIG. 4 shows a schematic cross-sectional view of a resist film-attached transparent resin substrate 40 formed through this step. In this step, typically, a resist film 41 provided with openings G is formed on the second metallic film 22 as shown in FIG. 4.

The resist film 41 is provided with openings G in a region where metallic thin wires are formed.

The region of the opening G in the resist film 41 can be appropriately adjusted in accordance with the region where metallic thin wires are to be disposed. For example, in a case where metallic thin wires are to be formed in a mesh, a resist film having mesh-like openings is formed. Usually, the openings are formed like thin wires in accordance with the metallic thin wires.

A line width W of the opening G is not particularly limited, and generally preferably 2.0 μm or less, more preferably 1.4 μm or less, and even more preferably 1.2 μm or less. In a case where the line width W of the opening is 1.4 μm or less, metallic thin wires to be obtained has a smaller width, and thus a user is less likely to visually recognizes the metallic thin wires in a case where a conductive film is applied to, for example, a touch panel sensor. The lower limit of the line width W of the opening G is not particularly limited, and 0.3 μm or greater in many cases.

In this specification, the line width W of the opening G denotes a size of a thin wire portion in a direction perpendicular to a direction in which a thin wire part of the opening G extends. Metallic thin wires having a line width W corresponding to the line width W of the opening G are formed through steps to be described later.

The method of forming a resist film 41 on the second metallic film 22 is not particularly limited, and a known resist film forming method can be used. Typical examples thereof include a method having the following steps.

(a) A step of applying a resist film forming composition to the second metallic film 22 to form a resist film forming composition layer 31 (FIG. 3 shows a schematic cross-sectional view of a resist film forming composition layer-attached transparent resin substrate 30 formed through the step (a)).

(b) A step of exposing the resist film forming composition layer 31 via a photomask provided with patterned openings.

(c) A step of developing the resist film forming composition layer 31 after the exposure to obtain a resist film 41 provided with openings G

A step of heating the resist film forming composition layer b 31 and/or the resist film 41 provided with openings G may be further included between the steps (a) and (b), between the steps (b) and (c), and/or after the step (c).

Step (a)

The resist film forming composition is not particularly limited, and a known resist film forming composition can be used.

Specific examples of the resist film forming composition include positive or negative radiation-sensitive compositions.

The method of applying the resist film forming composition to the second metallic film is not particularly limited, and a known application method can be used.

Examples of the method of applying the resist film forming composition include a spin coating method, a spray method, a roller coating method, and an immersion method.

The resist film forming composition layer may be heated after the resist film forming composition layer is formed on the second metallic film. Due to the heating, it is possible to remove the unnecessary solvent remaining in the resist film forming composition layer, and to make the resist film forming composition layer to have a uniform state. The method of heating the resist film forming composition layer is not particularly limited, and examples thereof include a method of heating the transparent resin substrate. The heating temperature is not particularly limited, and generally preferably 40° C. to 160° C.

The thickness of the resist film forming composition layer is not particularly limited, and generally preferably 0.5 to 2.5 μm as a thickness after the drying.

Step (b)

The method of exposing the resist film forming composition layer is not particularly limited, and a known exposure method can be used.

Examples of the method of exposing the resist film forming composition layer include a method of irradiating the resist film forming composition layer with active rays or radiation via a photomask provided with patterned openings. The exposure amount is not particularly limited, and in general, the exposure is preferably performed at 1 to 100 mW/cm² for 0.1 to 10 seconds.

For example, in a case where the resist film forming composition is a positive type, the line width W of the patterned openings of the photomask used in the step (b) is generally preferably 2.0 μm or less, and more preferably 1.4 μm or less.

The resist film forming composition layer after the exposure may be heated. The heating temperature is not particularly limited, and generally preferably 40° C. to 160° C.

Step (c)

The method of developing the resist film forming composition layer after the exposure is not particularly limited, and a known developing method can be used.

Examples of the known developing method include a method using a developer containing an organic solvent or an alkaline developer.

Examples of the developing method include a dipping method, a paddle method, a spray method, and a dynamic dispensing method.

The resist film after the development may be washed using a rinse liquid. The rinse liquid is not particularly limited, and a known rinse liquid can be used. Examples of the rinse liquid include organic solvents and water.

[Second Metallic Film Removing Step A]

The second metallic film removing step A is a step of removing the second metallic film in the openings of the resist film. That is, it is a step of removing the second metallic film exposed by the openings. FIG. 5 shows a schematic cross-sectional view of a resist film-attached transparent resin substrate 50 formed through this step, in which the second metallic film in the opening is removed. In this step, typically, the second metallic film 22 in the opening G of the resist film 41 is removed as shown in FIG. 5.

The method of removing the second metallic film 22 in the opening G of the resist film 41 is not particularly limited, and examples thereof include a method of removing the second metallic film 22 using an etching liquid with the use of the resist film 41 as a mask.

The etching liquid is not particularly limited as long as it can dissolve and remove the second metallic film 22, and a known etching liquid can be used. Examples thereof include a ferric chloride solution, a cupric chloride solution, an ammonia alkaline solution, a sulfuric acid-hydrogen peroxide mixed solution, and a phosphoric acid-hydrogen peroxide mixed solution.

In the method of manufacturing a conductive film, the first metallic film and the second metallic film functioning as a protective film for the first metallic film contain different metals (nickel and copper) as main components thereof. Nickel and copper significantly differ in the solubility to the etching liquid. Therefore, in the second metallic film removing step A, it is possible to remove only the second metallic film without damaging the first metallic film by adjusting an etching rate of the etching liquid for the second metallic film and an etching rate of the etching liquid for the first metallic film. In the following description, the etching liquid which is used in the second metallic film removing step A is referred to as a second etching liquid.

The etching rate of the second etching liquid for the second metallic film is not particularly limited. In view of the fact that it is possible to more easily obtain a conductive film provided with metallic thin wires having more excellent adhesiveness to the transparent resin substrate, the etching rate of the second etching liquid for the second metallic film is preferably 300 nm or less per minute (hereinafter, Anm per minute is denoted by “Anm/min”), and more preferably 200 nm/min or less.

The lower limit value of the etching rate of the second metallic film is not particularly limited, and generally preferably 30 nm/min or greater.

The etching rate of the second etching liquid for the second metallic film can be adjusted by adjusting the concentration of the second etching liquid, the temperature, and the like.

In this specification, the etching rate of each etching liquid for each metallic film denotes an etching rate measured by the following method.

(Etching Rate Measuring Method)

The etching rate of each etching liquid for each metallic film is measured by the following method.

First, a model substrate in which a target metallic film having a thickness of 10 μm is formed on a silicon wafer is prepared. Next, the thickness of the metallic film is measured after immersion of the model substrate in a target etching liquid for 5 minutes, and the thickness of the metallic film reduced before and after the immersion is calculated. The calculated result is divided by 5 (minutes) to calculate an etching rate.

In the thickness measurement, a surface shape measuring device Dektak 6M (manufactured by Veeco Instruments Inc.) is used.

The ratio of the etching rate (ER1) of the second etching liquid for the first metallic film to the etching rate (ER2) of the second etching liquid for the second metallic film (etching rate of first metallic film/etching rate of second metallic film, ER1/ER2) is not particularly limited, and preferably 0.01 or less, more preferably 0.002 or less, and even more preferably less than 0.0005 in view of the fact that the second etching liquid hardly dissolves the first metallic film (selectively dissolves the second metallic film).

The lower limit value of the above ratio is not particularly limited, and generally preferably 0 or greater.

The case where the above ratio is 0 denotes a case where the second etching liquid does not substantially dissolve the first metallic film.

It is possible to more easily obtain a conductive film provided with metallic thin wires having more excellent adhesiveness to the transparent resin substrate in a case Where the ratio ER1/ER2 of the second etching liquid is less than 0.0005.

The method of etching the second metallic film using the second etching liquid is not particularly limited, and a known method can be used.

[Third Metallic Film Forming Step]

The third metallic film forming step is a step of forming a third metallic film in the openings G of the resist film on the first metallic film by a plating method. FIG. 6 shows a schematic cross-sectional view of a third metallic film-attached transparent resin substrate 60 formed through this step. In this step, typically, a third metallic film 61 is formed on the first metallic film 12 so as to fill the openings G of the resist film 41 as shown in FIG. 6. As will be described later, the third metallic film 61 becomes a third metallic layer in the metal thin wire after a predetermined treatment.

The Third Metallic Film is Formed by a Plating Method.

A known plating method can be used as the plating method. Specific examples thereof include an electrolytic plating method and an electroless plating method, and an electrolytic plating method is preferable from the viewpoint of productivity.

The metal contained in the third metallic film is not particularly limited, and a known metal can be used. The third metallic film may contain, for example, metals such as copper, chromium, lead, nickel, gold, silver, tin, and zinc, and alloys thereof.

The main component of the third metallic film is preferably different from that of the first metallic film in view of different solubility to the etching liquid.

Especially, the third metallic film preferably contains copper as a main component in view of the fact that a third metallic layer to be formed after a treatment to be described later has more excellent conductive properties.

In a case where the third metallic film contains copper as a main component, the third metallic film may be a copper alloy as long as it contains copper as a main component. The third metallic film is preferably made of copper.

The main component denotes a metal having the largest content (mass) among metals contained in the third metallic film. The content of a constituent metal of the main component in the third metallic film is not particularly limited, and generally preferably 80 mass % or greater, and more preferably 90 mass % or greater.

In this specification, the state in which the third metallic film is made of copper denotes that the third metallic film does not substantially contain a component other than copper. The case where the third metallic film does not substantially contain a component other than copper includes a case where the third metallic film is made of copper and a case where the third metallic film unintentionally contains a component other than copper (typically, a case where a component other than copper is contained as impurities).

The thickness of the third metallic film is not particularly limited. The thickness is preferably 100 to 2,000 nm, and more preferably 200 to 1,500 nm. In a case where the thickness of the third metallic film is 200 to 1,500 nm, the third metallic film has a useful resistance value as a conductive film, and wiring fall hardly occurs.

[Resist Film Removing Step]

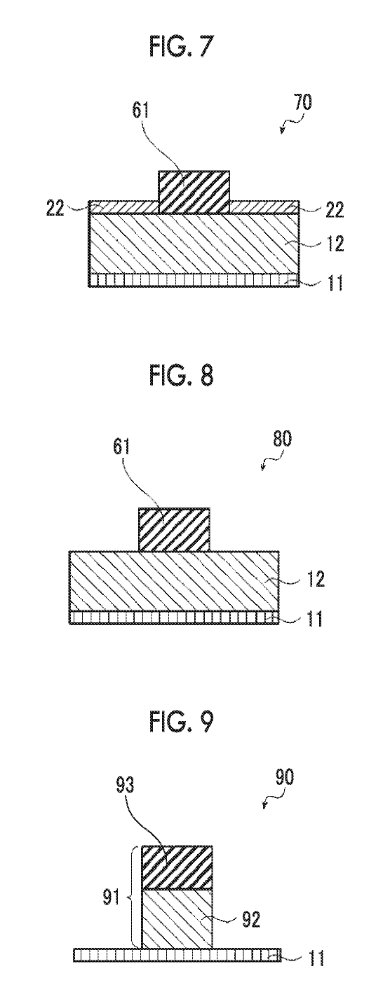

The resist film removing step is a step of removing the resist film. FIG. 7 is a schematic cross-sectional view of a third metallic film-attached transparent resin substrate 70 formed through this step, from which the resist film has been removed. In this step, typically, the resist film 41 is removed to obtain a laminate in which the third metallic film 61 is provided in a part where the first metallic film 12 is provided on the transparent resin substrate 11 and a metallic thin wire on the first metallic film 12 is to be formed, and the second metallic film 22 is provided in other parts as shown in FIGS. 6 and 7.

The method of removing the resist film is not particularly limited, and examples thereof include a method of removing a resist film using a known resist film removing liquid.

Examples of the resist film removing liquid include organic solvents and alkaline solutions.

The method of bringing the resist film removing solution into contact with the resist film is not particularly limited, and examples thereof include a dipping method, a paddle method, a spray method, and a dynamic dispensing method.

[Second Metallic Film Removing Step B]

The second metallic film removing step B is a step of removing the second metallic film on the first metallic film. FIG. 8 shows a schematic cross-sectional view of a third metallic film-attached transparent resin substrate 80 from which the remaining second metallic film has been removed. In this step, typically, the second metallic film 22 on the first metallic film 12 is selectively removed with an etching liquid to obtain a laminate provided with the transparent resin substrate 11, the first metallic film 12, and the third metallic film 61 in this order as shown in FIGS. 7 and 8.

The method of removing the second metallic film is not particularly limited, and the method described as the second metallic film removing step A is preferable. That is, the etching liquid is preferably selected so as not to damage the first metallic film while removing the second metallic film. A preferable embodiment of the etching liquid is as described above.

Since the first metallic film and the second metallic film contain, as main components thereof, metals different in solubility to the etching liquid, the second metallic film can be selectively removed in this step.

[First Metallic Film Removing Step]

The first metallic film removing step is a step of removing the first metallic film using the third metallic film as a mask. FIG. 9 shows a schematic cross-sectional view of a metallic thin wire formed through this step on the transparent resin substrate. By performing this step, the first metallic film in a region where no third metallic film is disposed immediately thereabove is removed, and a metallic thin wire is obtained. A conductive film 90 of FIG. 9 is provided with the transparent resin substrate 11 and a metallic thin wire 91. The metallic thin wire 91 is provided with a first metallic layer 92 and a third metallic layer 93 in order from the side of the transparent resin substrate 11.

The method of removing the first metallic film using the third metallic film as a mask is not particularly limited, and examples thereof include a method of removing the first metallic film using an etching liquid.

The etching liquid is not particularly limited as long as it can dissolve and remove the first metallic film, and a known etching liquid can be used.

In the method of manufacturing a conductive film, the third metallic film and the first metallic film contain different metals (nickel and copper) as main components thereof. Nickel and copper significantly differ in the solubility to the etching liquid. Therefore, in removing the first metallic film, it is possible to remove only the first metallic film without damaging the third metallic film by adjusting an etching rate of the etching liquid for the first metallic film and an etching rate of the etching liquid for the third metallic film. In the following description, the etching liquid which is used in the first metallic film removing step is referred to as a first etching liquid.

The etching rate of the first etching liquid for the first metallic film is not particularly limited. In view of the fact that it is possible to more easily obtain a conductive film provided with metallic thin wires having more excellent adhesiveness to the transparent resin substrate, the etching rate of the first etching liquid for the first metallic film is preferably 300 nm or less per minute (hereinafter, Anm per minute is denoted by “Anm/min”), and more preferably 200 nm/min or less.

The lower limit value of the etching rate of the first metallic film is not particularly limited, and generally preferably 30 nm/min or greater.

The etching rate of the first etching liquid for the first metallic film can be adjusted by adjusting the concentration of the first etching liquid, the temperature, and the like.

In this specification, the etching rate of each etching liquid for each metallic film denotes an etching rate measured by the above-described method.

The ratio of the etching rate (ER3) of the first etching liquid for the third metallic film to the etching rate (ER1) of the first etching liquid for the first metallic film (etching rate of third metallic film/etching rate of first metallic film, ER3/ER1) is not particularly limited, and preferably 0.01 or less, more preferably 0.002 or less, and even more preferably less than 0.0005 in view of the fact that the first etching liquid hardly dissolves the third metallic film (selectively dissolves the first metallic film).

The lower limit value of the above ratio is not particularly limited, and generally preferably 0 or greater.

The case where the above ratio is 0 denotes a case where the first etching liquid does not substantially dissolve the third metallic film.

It is possible to more easily obtain a conductive film provided with metallic thin wires having more excellent adhesiveness to the transparent resin substrate in a case where the ratio ER3/ER1 of the first etching liquid is less than 0.0005.

The method of etching the first metallic film using the first etching liquid is not particularly limited, and a known method can be used.

[Conductive Film]

A conductive film according to the embodiment of the invention is manufactured by the above-described procedure.

The conductive film according to the embodiment of the invention is provided with a transparent resin substrate and a conductive portion formed of metallic thin wires disposed on at least one main surface of the transparent resin substrate. Usually, the conductive portion is formed of a plurality of metallic thin wires in the conductive film. For example, in a case where the conductive film is used for a touch panel sensor, the conductive portion can be used as a transparent electrode and/or lead-out wiring.

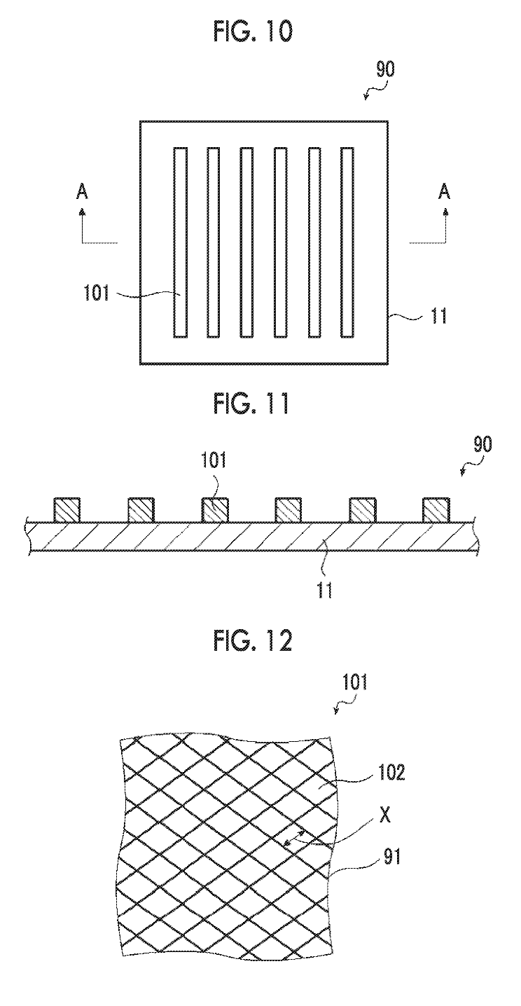

FIG. 10 is a top view of an embodiment of the conductive film, and FIG. 11 is a cross-sectional view taken along the line A-A of FIG. 10. FIG. 12 is a partially enlarged view of the conductive portion in the conductive film.

As shown in FIGS. 10 and 11, the conductive film 90 includes the transparent resin substrate 11 and a conductive portion 101 disposed on one main surface of the transparent resin substrate 11.

The conductive film has a planar shape in FIGS. 10 and 11. However, the shape of the conductive film is not limited thereto. The conductive film may have a three-dimensional shape (three-dimensional shape). Examples of the three-dimensional shape include a three-dimensional shape including a curved surface, and more specific examples thereof include a hemispherical shape, a semi-cylindrical shape, a corrugated shape, an uneven shape, and a cylindrical shape.

In FIGS. 10 and 11, the conductive portion 101 is disposed on one main surface of the transparent resin substrate 11. However, the invention is not limited to this form. For example, the conductive portion 101 may be disposed on both main surfaces of the transparent resin substrate 11.

In FIGS. 10 and 11, the conductive portions 101 are arranged in 6 stripes. However, the invention is not limited to this form, and any arrangement pattern may be used.

FIG. 12 is a partially enlarged top view of the conductive portion 101. The conductive portion 101 includes a mesh-like pattern formed of a plurality of metallic thin wires 91 and including a plurality of openings 102 formed by the intersecting metallic thin wires 91.

The width of the metallic thin wire 91 is 2.0 μm or less, more preferably 1.4 μm or less, and even more preferably 1.2 μm or less.

The lower limit value of the width of the metallic thin wire 91 is not particularly limited, and generally preferably 0.3 μm or greater.

In a case where the width of the metallic thin wire 91 is preferably 2.0 μm or less, a touch panel's user is less likely to visually recognize the metallic thin wires in a case where a conductive film is applied to, for example, a touch panel sensor.

In this specification, the width of the metallic thin wire 91 denotes the largest one of the line widths of the first metallic layer and the third metallic layer to be described later in a cross-section in the width direction of the metallic thin wire 91 (a cross-section perpendicular to a direction in which the metallic thin wire extends). That is, the line widths of the first metallic layer and the third metallic layer are equal to or smaller than the width of the metallic thin wire 91.

The forms of the metallic layers and the line width measuring method will be described later.

The thickness of the metallic thin wire 91 is not particularly limited, and generally preferably 0.1 to 5.0 μm. The thickness is more preferably 0.2 to 2.0 μm from the viewpoint of conductivity.

A length X of one side of the opening 102 is preferably 20 to 250 μm.

In FIG. 12, the opening 102 has a substantially rhombus shape. However, the opening may have another polygonal shape (for example, a triangle, a quadrangle, a hexagon, or a random polygon). Furthermore, the shape of one side may be a curved shape or an arc shape other than a linear shape. In a case of an arc shape, for example, two opposing sides may have an outwardly convex arc shape, and other two opposing sides may have an inwardly convex arc shape. Each side may have a wavy line shape in which outward convex arcs and inward convex arcs continue. Each side may have a sine curve shape.

In FIG. 12, the conductive portion 101 has a mesh-like pattern, but the invention is not limited to this form.

The variation in the width of the metallic thin wires of the conductive film according to this embodiment is not particularly limited. The variation is preferably 15% or less, and more preferably 10% or less.

In this specification, the width of the metallic thin wires and the variation in the line width denote a line width and a variation in the line width measured by the following method, respectively.

First, the conductive film is embedded entirely with the transparent resin substrate in a resin, and cut in the width direction (a direction perpendicular to the direction in which the metallic thin wire extends) using an ultramicrotome, and carbon is deposited on the obtained cross-section. Then, the cross-section is observed using a scanning electron microscope (S-5500 manufactured by Hitachi High-Technologies Corporation). A line width of the metallic thin wire is randomly measured at 20 points in an observation range of 3 cm×3 cm, and an average value of the measured values is calculated. The standard deviation of the line width with respect to the average value is expressed as percentage, and this is defined as the variation. That is, the variation (%) in the line width is calculated by {(standard deviation of line width)/average value×100}.

As a cross-sectional view of the metallic thin wire 91, for example, as shown in FIG. 9, the metallic thin wire 91 has a structure provided with the first metallic layer 92 and the third metallic layer 93 in order from the side of the transparent resin substrate 11. The shapes of the first metallic layer 92 and the third metallic layer 93 are all thin wire shapes corresponding. to the shape of the metallic thin wire 91.

[First Metallic Layer]

The first metallic layer 92 has conductivity and acts to hold the third metallic layer 93 disposed thereon on the transparent resin substrate (acts to improve adhesiveness). As described above, the first metallic layer 92 is formed by performing an etching treatment on the first metallic film.

The type of the metal contained in the first metallic layer 92 is the same as the type of the metal contained in the above-described first metallic film.

In addition, the preferable range of the thickness of the first metallic layer 92 is the same as the preferable range of the thickness of the above-described first metallic film. The thickness of the first metallic layer in the conductive film can be measured together in the measurement of the line width of the first metallic layer to be described later.

The line width of the first metallic layer 92 is preferably 2.0 μm or less, more preferably 1.4 μm or less, and even more preferably 1.2 μm or less.

The line width of the first metallic layer 92 denotes a line width which is measured by observation using a scanning electron microscope (S-5500 manufactured by Hitachi High-Technologies Corporation) after the metallic thin wire 91 is embedded entirely with the transparent resin substrate 11 in a resin, and cut in the width direction (a direction perpendicular to the direction in which the metallic thin wire extends) using an ultramicrotome, and carbon is deposited on the obtained cross-section. The line width of the third metallic layer 93 to be described later is also obtained in the same manner.

[Third Metallic Layer]

The third metallic layer 93 has conductivity and acts to secure conduction of the metallic thin wire.

The type of the metal contained in the third metallic layer 93 is the same as the type of the metal contained in the above-described third metallic film.

In addition, the preferable range of the thickness of the third metallic layer 93 is the same as the preferable range of the thickness of the above-described third metallic film. The thickness of the third metallic layer in the conductive film can be measured together in the measurement of the line width of the first metallic layer described above.

The line width of the third metallic layer 93 is preferably 2.0 μm or less, more preferably 1.4 μm or less, and even more preferably 1.2 μm or less.

The conductive film manufactured by the above-described manufacturing method can be used for various purposes. For example, it is used for various electrode films, heat generating sheets, and printed wiring boards. Especially, the conductive film is preferably used for touch panel sensors, and more preferably for capacitive touch panel sensors. In a touch panel including the conductive film as a touch panel sensor, the metallic thin wire is hardly visually recognized.

Examples of the configuration of the touch panel include a touch panel module described in paragraphs 0020 to 0027 of JP2015-195004A, and the content thereof is incorporated in this specification.

### EXAMPLES

Hereinafter, the invention will be described in greater detail based on examples. Materials, used amounts, ratios, treatment contents, treatment procedures, and the like shown in the following examples are able to be properly changed without departing from the gist of the invention. Therefore, the scope of the invention will not be restrictively interpreted by the following specific examples.

### Example 1

### Production of Conductive Film

A 50 nm thick Ni film was formed as a first metallic film (seed layer) on a cyclo-olefin polymer (COP) film (corresponding to a transparent substrate and having a thickness of 80 μm using a sputtering device, and a 20 nm thick Cu film was formed as a second metallic film to obtain a second metallic film-attached substrate. Next, a resist composition (positive resist, trade name “MCPR124MG” manufactured by DOW) was applied to the second metallic film of the second metallic film-attached substrate by a spin coater such that a thickness after drying was 1 μm, and drying was performed for 10 minutes at 90° C. to obtain a resist film forming composition layer-attached substrate. Next, the resist film forming composition layer-attached substrate was irradiated with light having a wavelength of 365 nm (the exposure amount was 13 mW/cm²) for 2 seconds via a photomask using a parallel exposure machine, and then developed with a 0.15 M sodium hydroxide aqueous solution to obtain a substrate having a resist film provided with openings (the line width of the opening was 1.2 μm±0.1 μm). In the opening, a metallic thin wire is formed in a later step.

Next, the entire surface of the resist film was exposed (irradiated with light for 3 seconds at 13 mW/cm²) for later peeling. Next, using a Cu etching liquid (trade name “Cu etchant”, manufactured by FUJIFILM Wako Pure Chemical Corporation), the second metallic film (Cu layer) in the opening on the resist film-attached substrate was removed, and a substrate from which the second metallic film in the opening had been removed was obtained. Next, the substrate from which the second metallic film in the opening had been removed was subjected to electroplating (current density: 3 A/dm²) using a copper sulfate high-throwing bath (containing “TOP LUCINA HT-A” and “TOP LUCINA HT-B” as additives, all manufactured by Okuno chemical Industries Co., Ltd.) to form a copper plating film (corresponding to a third metallic film having a thickness of 300 nm) in the opening, and a third metallic film-attached substrate was obtained. Next, the resist film was peeled off from the third metallic film-attached substrate using a 0.15 M sodium hydroxide aqueous solution, and then the remaining second metallic film (Cu layer) was removed using a Cu etching liquid (trade name “Cu etchant”, manufactured by FUJIFILM Wako Pure Chemical Corporation). Next, using a Ni etching liquid (trade names “NC-A” and “NC-B”, manufactured by NIHON KAGAKU SANGYO CO., LTD.), the first metallic film (Ni layer) was removed with the use of the third metallic film as a mask, and a conductive film provided with metallic thin wires was obtained. In the obtained conductive film, the thickness of the third metallic layer was 270 nm.

### Examples 2 to 5

### Production of Conductive Film

Conductive films 2 to 5 of Examples 2 to 5 were produced in the same manner as in the case of the conductive film of Example 1, except that the thickness of the second metallic film was as described in Table 1. In the obtained conductive films, the thicknesses of the third metallic layers were 280 nm, 250 nm, 240 nm, and 275 nm in order from the conductive film 2, respectively.

### Comparative Example 1

A 50 nm thick Cu film was formed as a first metallic film (seed layer) on a COP film using a sputtering device. Without the formation of a second metallic film, a resist composition (positive resist, trade name “MCPR124MG” manufactured by DOW) was applied to the first metallic film by a spin coater such that a thickness after drying was 1 μm. Drying was performed for 10 minutes at 90° C., and thus a resist film forming composition layer-attached substrate was obtained. Next, the resist film forming composition layer-attached substrate was irradiated with light having a wavelength of 365 nm (the exposure amount was 13 mW/cm²) for 2 seconds via a photomask using a parallel exposure machine, and then developed with a 0.15 M sodium hydroxide aqueous solution to obtain a substrate having a resist film provided with openings (the line width of the opening was 1.2 μm±0.1 μm). Next, the entire surface of the resist film was exposed (irradiated with light for 3 seconds at 13 mW/cm²) for later peeling. Next, the substrate having a resist film provided with openings was subjected to electroplating (current density: 3 A/dm²) using a copper sulfate high-throwing bath (containing “TOP LUCINA HT-A” and “TOP LUCINA HT-B” as additives, all manufactured by Okuno chemical Industries Co., Ltd.) to form a copper plating film (corresponding to a third metallic film having a thickness of 300 nm) in the opening, and a third metallic film-attached substrate was obtained. Next, the resist film was peeled off from the third metallic film-attached substrate using a 0.15 M sodium hydroxide aqueous solution, and then the first metallic film (Cu layer) was removed using a Cu etching liquid (trade name “Cu etchant”, manufactured by FUJIFILM Wako Pure Chemical Corporation) with the use of the third metallic film as a mask, and a conductive film provided with metallic thin wires was obtained.

### Comparative Example 2

A 40 nm thick Ni film was formed as a first metallic film (seed layer) on a COP film using a sputtering device. Without the formation of a second metallic film, a resist composition (positive resist, trade name “MCPR124MG” manufactured by DOW) was applied to the first metallic film by a spin coater such that a thickness after drying was 1 μm. Drying was performed for 10 minutes at 90° C., and thus a resist film forming composition layer-attached substrate was obtained. Next, the resist film forming composition layer-attached substrate was irradiated with light having a wavelength of 365 nm (the exposure amount was 13 mW/cm²) for 2 seconds via a photomask using a parallel exposure machine, and then developed with a 0.15 M sodium hydroxide aqueous solution to obtain a substrate having a resist film provided with openings (the line width of the opening was 1.2 μm±0.1 μm). Next, the entire surface of the resist film was exposed (irradiated with light for 3 seconds at 13 mW/cm²) for later peeling. Next, electroplating (current density: 3 A/dm²) was performed using a copper sulfate high-throwing bath (containing “TOP LUCINA HT-A” and “TOP LUCINA HT-B” as additives, all manufactured by Okuno chemical industries Co., Ltd.) to form a copper plating film (corresponding to a third metallic film having a thickness of 300 nm) in the opening, and a third metallic film-attached substrate was obtained. Next, the resist film was peeled off from the third metallic film-attached substrate using a 0.15 M sodium hydroxide aqueous solution, and at this time, the third metallic film formed in the opening was also peeled off from the first metallic film (Ni layer). Thus, a conductive film provided with metallic thin wires was not obtained.

Each conductive film was evaluated by the following methods.

[Metallic Thin Wire Formability]

The conductive films produced by the above-described method were used, and with a finger cushion, a cellophane tape film (“CT24” manufactured by Nichiban Co., Ltd.) was pressed against and brought into close contact with the main surface of the substrate provided with the metallic thin wires. Then, the cellophane tape was peeled off. After that, peeling of the metal thin wires on the substrate was visually confirmed.

The results were evaluated according to the following criteria, and the evaluation results were shown in Table 1. The symbol “−” in Table 1 represents no metallic thin wires were formed.

A: Metallic thin wires were formed, and peeling of the metallic thin wires was not observed in the test.

B: Metallic thin wires were formed, but peeling of the metallic thin wires was observed in the test.

[Variation in Width of Metallic Thin Wires]

Regarding the conductive film of the examples and the comparative examples, a variation in the width of the metallic thin wires was measured by the following method.

First, the conductive film was embedded entirely with the transparent resin substrate in a resin, and cut in the width direction (a direction perpendicular to the direction in which the metallic thin wire extended) using an ultramicrotome, and carbon was deposited on the obtained cross-section. Then, the cross-section was observed using a scanning electron microscope (S-5500 manufactured by Hitachi High-Technologies Corporation). A line width of the metallic thin wire was randomly measured at 20 points in an observation range of 3 cm×3 cm, and an average value of the measured values was calculated. The standard deviation of the line width with respect to the average value was expressed as percentage, and this was defined as the variation. The results were evaluated according to the following criteria, and shown in Table 1.

Evaluation Criteria

A: The variation in the width of the metallic thin wires was 10% or less.

B: The variation in the width of the metallic thin wires was greater than 10%.

TABLE 1

| | Method of Manufacturing Conductive Film | | | | Evaluation | |
|---|---|---|---|---|---|---|
| | First | Second | Third | | | Variation in |
| | Metallic Film | Metallic Film | Metallic Film | Conductive | Metallic | Width of |
| | (film | (film | (film | Film | Thin Wire | Metallic |
| | thickness) | thickness) | thickness) | Line Width | Formability | Thin Wires |
| Example 1 | Ni (50 nm) | Cu (20 nm) | Cu (300 nm) | 1.1 μm | A | A |
| Example 2 | Nt (50 nm) | Cu (10 nm) | Cu (300 nm) | 1.12 μm | A | A |
| Example 3 | Ni (50 nm) | Cu (40 nm) | Cu (300 nm) | 1.05 μm | A | A |
| Example 4 | Ni (50 nm) | Cu (50 nm) | Cu (300 nm) | 1.01 μm | A | B |
| Example 5 | Ni (20 nm) | Cu (10 nm) | Cu (300 nm) | 1.13 μm | A | A |
| Comparative | Cu (50 nm) | None | Cu (300 nm) | 1.02 μm | B | B |
| Example 1 | | | | | | |
| Comparative | Ni (50 nm) | Note | Cu (300 nm) | — | B | — |
| Example 2 | | | | | | |

In Table 1, the symbol “−” described in the column of the variation in the width of the metallic thin wires represents that no metallic thin wires were obtained.

From the results described in Table 1, the conductive films obtained by the method of manufacturing a conductive film according to the embodiment of the invention were provided with metallic thin wires having excellent adhesiveness to the transparent resin substrate.

On the other hand, in the conductive film described in Comparative Example 1, since the first metallic layer contained copper as a main component, the adhesiveness to the transparent resin substrate was not sufficient, and the metallic thin wire formability was poor. In addition, in removing the first metallic film, a part of the copper plating layer (corresponding to the third metallic film) (particularly, a side surface portion of the copper plating layer) was also removed, and the variation in the width of the metallic thin wires was large.

In the conductive film described in Comparative Example 2, no metallic thin wires could be formed. The reason for this is presumed to be that since no second metallic film was formed on the first metallic film, Ni in the first metallic film was oxidized and the adhesiveness to the plating layer deteriorated.

In addition, the conductive films of Examples 1 to 3 in which the line width of the opening of the resist film was 1.4 μm or less and the thickness of the second metallic film was less than 50 nm had a smaller variation in the width of the metallic thin wires than in the conductive film of Example 4.

### EXPLANATION OF REFERENCES

10: first metallic film-attached transparent resin substrate

11: transparent resin substrate

12: first metallic film

20: second metallic film-attached transparent resin substrate

22: second metallic film

30: resist film forming composition layer-attached transparent resin substrate

31: resist film forming composition layer

40: resist film-attached transparent resin substrate

41: resist film

50: resist film-attached transparent resin substrate from which second metallic film in opening has been removed

60: third metallic film-attached transparent resin substrate

61: third metallic film

70: third metallic film-attached transparent resin substrate from which resist film has been removed

80: third metallic film-attached transparent resin substrate from which remaining second metallic film has been removed

90: conductive film

91: metallic thin wire

92: first metallic layer

93: third metallic layer

101: conductive portion

What is claimed is:

1. A method of manufacturing a conductive film provided with a transparent resin substrate and a conductive portion formed of metallic thin wires disposed on at least one main surface of the transparent resin substrate, the method comprising, in order:
forming a first metallic film containing nickel as a main component on at least one main surface of the transparent resin substrate so as to be in contact with the transparent resin substrate;
forming a second metallic film containing copper as a main component on the first metallic film so as to be in contact with the first metallic film;
forming, on the second metallic film, a resist film provided with openings in a region where the metallic thin wires are formed;
removing the second metallic film in the openings;
forming a third metallic film on the first metallic film in the openings by a plating method;
removing the resist film;
removing the second metallic film on the first metallic film, and
removing the first metallic film using the third metallic film as a mask.

2. The method of manufacturing a conductive film according to claim 1,
wherein a line width of the openings is 2.0 μm or less.

3. The method of manufacturing a conductive film according to claim 1,
wherein a line width of the openings is 1.4 μm or less, and a thickness of the second metallic film is less than 50 nm.

4. The method of manufacturing a conductive film according to claim 2,
wherein a line width of the openings is 1.4 μm or less, and a thickness of the second metallic film is less than 50 nm.

5. The method of manufacturing a conductive film according to claim 1,
wherein a thickness of the third metallic film is 200 to 1,500 nm.

6. The method of manufacturing a conductive film according to claim 2,
wherein a thickness of the third metallic film is 200 to 1,500 nm.

7. The method of manufacturing a conductive film according to claim 3,
wherein a thickness of the third metallic film is 200 to 1,500 mm

8. The method of manufacturing a conductive film according to claim 4,
wherein a thickness of the third metallic film is 200 to 1,500 nm.

9. A conductive film comprising:
a transparent resin substrate; and
a conductive portion formed of metallic thin wires disposed on at least one main surface of the transparent resin substrate,
wherein the metallic thin wires have a first metallic layer containing nickel as a main component and a third metallic layer containing copper as a main component in order from the transparent resin substrate,
the first metallic layer is in contact with the transparent resin substrate, and
a line width of the metallic thin wires is 2.0 μm or less.

10. The conductive film according to claim 9,
wherein a variation in the line width of the metallic thin wires is 10% or less.

11. The conductive film according to claim 9,
wherein a thickness of the third metallic layer is 200 to 1,500 nm.

12. The conductive film according to claim 10,
wherein a thickness of the third metallic layer is 200 to 1,500 nm.
